(19) United States
(12) Patent Application Publication
(10) Pub. No.: US 2008/0214238 A1
(43) Pub. Date: Sep. 4, 2008

(54) DEVICES AND METHODS FOR FACILITATING HANDS-FREE MODE WITH FM TRANSMITTER

(75) Inventors: DANIEL S. ROKUSEK, LONG GROVE, IL (US); DAVID A. VANYEK, LIBERTYVILLE, IL (US); KEVIN L. WEIRICH, ALGONQUIN, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/680,897

(22) Filed: Mar. 1, 2007

(51) Int. Cl. H04B 1/38

(52) U.S. Cl. 455/557

(57) ABSTRACT

Disclosed is a hands-free electronic device including an FM receiver and an FM scanner to continuously scan for FM channels and to locate available FM channels for a list of available FM channels rated according to signal-to-noise ratio (SNR) and/or a received signal-strength indication (RSSI). A short range transceiver may transmit and receive short range communications, from a handheld device. An FM transmitter of the hands-free device can transmit received short range communications via available FM channels of the rated list of available FM channels. The hands-free device may be in communication with, for example, an automobile FM radio. In this way, the car radio may audibly output that which is transmitted from the handheld device. In an embodiment, a speech synthesizer may be configured to generate speech output to indicate an available FM channel from the rated list of available FM channels.

### FIELD

Disclosed are devices and methods for facilitating hands-free voice and music modes with an FM transmitter, and more particularly devices and methods for rating and using an available FM channel.

### BACKGROUND

The makers of wireless communication devices, including those of cellular telephones, are increasingly adding functionality to their devices. For example, cellular telephones include features such as music players and FM radios including stereo audio capabilities. The memory capacity of a wireless communication device may be equivalent to, for example, an MP3 player. Therefore a wireless communication device may operate as an audio entertainment device in addition to providing communication functions.

For mobile communication devices such as cellular telephones, a hands-free device such as a headset can provide hands-free operation in a driving situation that is important for both convenience and safety. In fact, in some jurisdictions, operating a handheld device while driving may be outlawed. A hands-free (HF) device may have one of many different configurations. A hands-free device, for example, may be a headset or may be a stand-alone device that includes a speakerphone.

As mentioned above, a wireless communication device may include both communication and music playback capabilities as well as other features. A user may wish to utilize two or more capabilities with a hands-free device, particularly while in an automobile. Moreover, cars are often equipped with audio equipment including FM radios and speaker systems that may be superior to those of a hands-free device and/or that of the wireless communication device or other handheld device. Accordingly, a user may wish to utilize the automobile audio equipment for audio output of the wireless communication device or other handheld device.

A hands-free device can receive transmitted signals from a handheld device, for example, via Bluetooth, and in turn can transmit an FM signal for receipt by the automobile audio equipment for audio output. Therefore, a user may be able to listen to voice communication and/or music playback output on the superior speaker set of an automobile. Accordingly, a hands-free device may be tuned to transmit the voice and/or music data over a particular FM channel. Processing an available FM channel is performed manually by the user. Accordingly there may be an introduction of safety issues realized when an available FM channel experiences interference. That is, when an FM channel currently in use by the hands-free device experiences interference, a user must manually locate a new available FM channel and then must manually tune the hands-free device and the FM radio to a new available FM channel.

### BRIEF DESCRIPTIONS OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts an electronic device, such as a hands-free device that may be configured for wireless short range communication and FM communication;

FIG. 2 is a flowchart of an embodiment of a method for generating a rated list and an updated rated list by a hands-free electronic device;

FIG. 3 is a flowchart of an embodiment of a method for powering up and initiating FM communication between a hands-free electronic device and an FM radio according to the last used FM channel;

FIG. 4 is a flowchart of an embodiment of a method for informing a user as to which channel to tune the FM radio; and

FIG. 5 is a flowchart of an embodiment of a power saving method of the hands-free electronic device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

It would be beneficial if processing of an available FM channel were automatically determined by a hands-free device, in order to avoid distraction safety issues that may be present when a user operates communication devices while operating a motor vehicle. In one embodiment of the disclosed hands-free device, the processing of an available FM channel may be completely hands-free if an automobile FM tuner were configured to receive and process tuning information from the hands-free device. In another embodiment of the disclosed hands-free device a user may receive audible information from the hands-free device to tune the FM tuner to a particular FM channel that has been determined by the hands-free device to be substantially free of interference. In this way, the hands-free device can provide to the user the information that may direct the user to tune the FM tuner to a particular FM channel that the hands-free device has automatically determined to be substantially free of interference. In this way a user does nothing more than tune a radio as he or she would were he or she only listening to the radio.

Disclosed is an electronic device, such as a hands-free device, including an FM receiver and an FM scanner configured to continuously scan for FM channels and to locate available FM channels for a rated list of available FM channels. A short range transceiver may transmit and receive short range communications, from for example, a handheld device such as a cellular telephone. An FM transmitter of the hands-free device can transmit received short range communications via at least one of the available FM channels of the rated list of available FM channels. The hands-free device may be in communication with, for example, an automobile FM radio. In this way, the car FM radio may audibly output that which is transmitted from the handheld device. Since the rated list of available FM channels can be continuously updated, the audio output of the handheld device from the car FM radio may be of a high quality.

In one embodiment, a speech synthesizer may be configured to generate speech output to indicate at least one available FM channel from the rated list of available FM channels. A user may manually tune the FM radio based on the speech output to indicate an FM channel. As mentioned above, in another embodiment, the FM radio may be in wireless communication with the hands-free device to receive a signal indicating at least one available FM channel from the rated list of available FM channels. In either event, the FM radio may be tuned to receive a signal from the hands-free device via an FM channel from a continuously updated rated list of available FM channels, and in particular, via an FM channel that may be ranked according to a signal-to-noise ratio (SNR) and/or a received signal-strength indication (RSSI) and/or other ranking criteria. In this way, there may be less or no need for a user to be distracted in tuning the car FM radio while operating the hands-free device in conjunction with a wireless communication device and a car FM radio.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

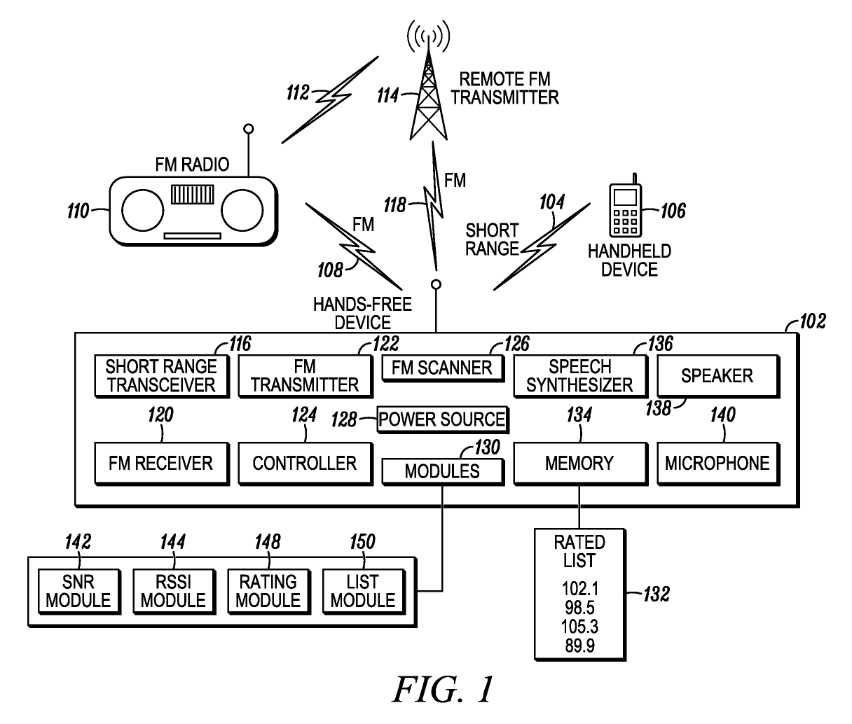

FIG. 1 depicts an electronic device, such as a hands-free device that may be configured for both wireless short range communication and FM communication. That is, the device 102 can first receive short range communication 104 from a handheld device 106 such as a cellular telephone. The device 102 may transmit via FM communication 108 to an automobile FM radio 110 the received short range communication 104, on an available FM channel. It is understood that the hands-free device 102 may be configured to receive short range communication 104 from a handheld device 106 via a wireless communication link or via a wired communication link. It is further understood that the hands-free device may transmit via FM communication 108, the received short range communication 104 on an available FM channel, to an FM radio 110 that may be other than an automobile FM radio.

Continuous scanning for available FM channels may be performed automatically by the hands-free device 102, in order to avoid distraction safety issues that may be present when a user operates communication devices while operating a motor vehicle. As discussed below, if the automobile FM tuner 110 should be configured to receive tuning information from the hands-free device 102, the process may be completely hands-free. Otherwise, a user may receive audible information from the hands-free device 102 to tune the FM tuner 110 to a particular FM channel. By continuously scanning the FM radio spectrum, the hands-free device 102 may determine the particular FM channel to be substantially free of interference. In this way, the hands-free device 102 may provide to the user the information that may direct the user to tune the FM tuner 110 to a particular FM channel. Thus, there may be less or no need for a user to be distracted in tuning the automobile FM radio 110 while operating the hands-free device 102 in conjunction with a wireless communication device 106 and a car FM radio 110, so that safety issues associated with finding an available FM channel may be mitigated.

The handheld device 106 may be one of any number of handheld devices including mobile communication devices, MP3 players or other music players, navigation devices, video gaming devices, and the like. The mobile communication device 106 may be implemented as a cellular telephone (also called a mobile phone). The mobile communication device 106 represents a wide variety of devices that have been developed for use within various networks. Such handheld communication devices include, for example, cellular telephones, messaging devices, navigation devices such as GPS, personal digital assistants (PDAs), notebook or laptop computers incorporating communication modems, mobile data terminals, application specific gaming devices, video gaming devices incorporating wireless modems, and the like. Any of these handheld devices may be referred to as a mobile station or user equipment. Herein, wireless communication technologies may include, for example, voice communication, the capability of transferring digital data, SMS messaging, Internet access, multi-media content access and/or voice over internet protocol (VoIP). The handheld device may provide to a user different types of data, including text, voice, music, navigational data, and the like. The handheld device may include capabilities such as voice recognition, global positioning system (GPS) functionality, and/or text-to-speech capability.

The FM radio 110 may be, for example, any type. It may be configured to receive FM communication signals 112 from, for example, a remote FM transmitter 114 in a frequency range from approximately 87.9 MHz to approximately 107.9 MHz, for example, in the United States. FM channels may be defined at every 0.2 MHz, that is, 87.9 MHz, 88.1 MHz, and so on, up to 107.9 MHz in the U.S. In other countries FM frequency allocations may be different. For example, in Japan, FM transmissions can occur between 76 MHz and 90 MHz, with FM channels every 0.1 MHZ. Any configuration of FM channels is within the scope of this disclosure. The FM radio 110 may be configured to receive Radio Data System (RDS) data, and to display and/or process the RDS data. It may be possible to connect multiple handheld devices to the handsfree device simultaneously.

Turning now to a more detailed description of the hands-free device 102, just as the FM radio 110 can receive FM communications 112, so too can the hands-free device 102. FM communication signals may be transmitted from a remote FM transmitter 114 via commercial signals 118 and received by an FM receiver 120 of the device 102. By continuously scanning for available FM channels, a rated list can be generated so that data received via the short range transceiver 116 may be in turn transmitted by an FM transmitter 122 to the radio 110 over an available FM channel substantially free of interference.

The short range transceiver 116 of the hands-free device 102 may be configured to transmit and receive short range communications from the handheld device 106 including data that a user may wish to hear over the speakers of the automobile or over other superior speakers. The short range transceiver 116 may be for example, a Bluetooth transceiver or a WiFi transceiver. The device 102 may in addition include an input jack or other connector to communicate with and receive input from the handheld device 106. Both the transceiver 116 and the FM transmitter 122 may be coupled to a controller 124 which may be configured to control the operations of the short range transceiver 116 and the FM transmitter 122.

A rated list generated by the device 102 of available FM channels may provide automatic or semi-automatic tuning of the radio 110. The FM receiver 120 may be coupled to the controller 124 and configured to receive an FM radio signal 118 from the FM transmitter 114 so that the FM receiver 120 may be configured in conjunction with the controller 124 to determine a received signal strength, or a received signal strength indication (RSSI), for the FM radio signal 118 received from the FM transmitter 114. In the presence of interfering signals on the FM channel from broadcasters 114 or sources of electromagnetic noise, the FM receiver 120 may be configured in conjunction with the controller 124 to determine a signal-to-noise ratio (SNR) value for the FM radio signal received from the FM transmitter. A rated list may therefore be generated according to signal-to-noise ratio (SNR) and/or other criteria.

It is understood that short range transceiver 116, FM transmitter 122, and FM receiver 120 may be connected to separate antennas so as to provide for separate transmission and reception capabilities. In addition, the device 102 may include an FM scanner 126 coupled to the FM receiver 120. The FM scanner 126 may be configured to continuously scan for FM channels and to locate available FM channels. As mentioned, available FM channels may be rated and stored in a list, as described below.

An available FM channel is one not currently in use for FM transmission by any nearby commercial, or other, FM radio broadcaster, and so may be available for use by the hands-free device 102 for FM transmission to the FM radio 110. The FM scanner 126 may be configured to discontinue scanning when the short range transceiver 116 is not receiving short range communications. By discontinuing scanning when the short range transceiver 116 does not receive short range communications over a predetermined period of time e.g. one minute, power consumption of the hands-free device 102 may be reduced, and may prolong the life (i.e. charge) of its power source 128.

In an embodiment, the hands-free device 102 may be configured to draw power from the vehicle electrical system via a vehicle power adapter (VPA). In another embodiment, the device 102 may include its own power source 128, for example, a battery. With inclusion of a power source 128, the hands-free device 102 may be more self-contained, and its portability may be improved. The hands-free device 102 therefore need not be installed in a particular automobile, but may be carried from one automobile to another as the need may arise. The device 102 may be used in other environments including, for example, an office, an outdoor event, and any other situation where an FM radio 110 and a handheld device 102 may be used in conjunction with each other. As mentioned above, discontinuing scanning when the short range transceiver 116 receives no short range communications 104 may reduce power consumption of the hands-free device 102, and may prolong the life of the device power source 128.

The hands-free device 102 may include one or more instruction module(s) 130 coupled to the controller 124 and configured to generate the above-described rated list 132 of the available FM channels. The hands-free device 102 may also include a memory 134, a speech synthesizer 136, a speaker 138, and a microphone 140. Each of these will be described in turn.

The instruction module 130 may include a plurality of modules such as for example, an SNR module 142 configured to generate a signal-to-noise ratio (SNR) value for an available FM channel and a received signal strength indication module 144 configured to generate a received signal strength indication (RSSI). The instruction module 130 may also include a rating module 148 configured to rate available FM channels according to predetermined criteria such as the SNR and the RSSI. The instruction module 130 may include a list module 150 configured to generate a list according to the rating of the available FM channels by the rating module 148.

Steps of methods may involve modules, and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

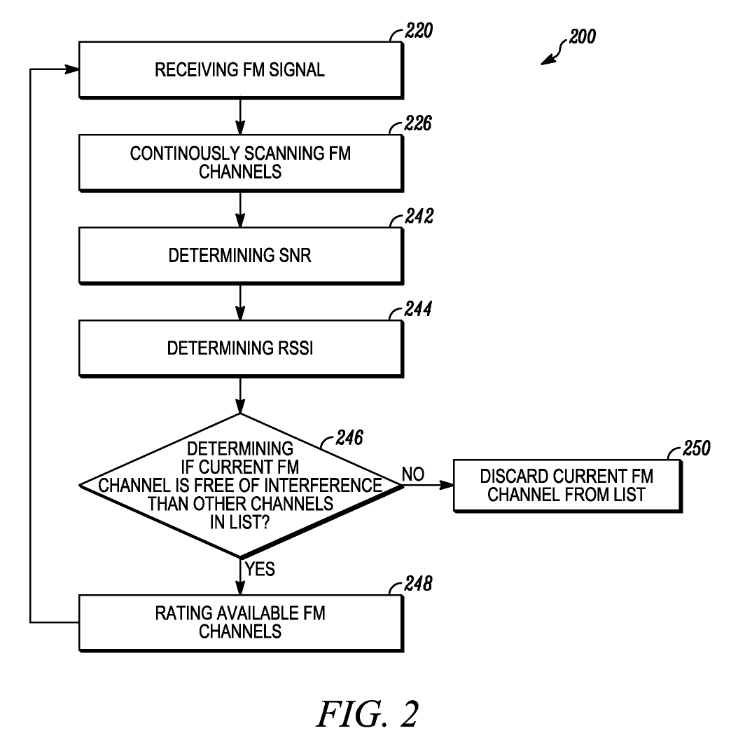

When powering up the device 102, to quickly provide audio output of the FM radio 110, an initial mode of operation may be to transmit from the device 102 to the FM radio 110 over the last used available FM channel. As scanning progresses, and the list is revised and updated, the last used entry may be replaced with a better available FM channel. Accordingly, the rated list 132 may include, for example, as a first entry a last used available FM channel, which in an embodiment may be denoted for example by its frequency in MHz, such as 102.1. The entries on the rated list 132 may be rated according to a SNR value and a RSSI. The memory 134 may be coupled to the controller 124 and configured to store the rated list 132 of the available FM channels. Generation of the rated list of the available FM channels is further described below in connection with FIG. 2.

As discussed above, the hands-free device 102 may be in communication with both the FM radio 110 and the handheld device 106. The FM transmitter 122 of the device 102 may be configured to transmit received short range communications 104 from the handheld device 106 via at least one of the available FM channels of the rated list 132 of available FM channels.

As mentioned above, in one embodiment the FM radio 110 and the device 102 may be in communication so that the radio 110 may be automatically tuned to an FM channel of the rated list 132. On the other hand, if the FM radio 110 is not retrofitted or manufactured to communicate with the device 102 for automatic tuning, the hands-free device may include a speech synthesizer 136 as mentioned above to provide audible output to the user so that he or she may tune the FM radio 110. The speech synthesizer 136 may be coupled to the controller 124 and configured to generate speech output to indicate at least one available FM channel from the rated list 132 of available FM channels. In this way a user may receive over speaker 138 an audible indication of an FM channel to which to manually tune the FM radio 110 if necessary to do so. The controller 124 may be configured to initiate a transmission by the FM transmitter 122 of a tuning signal including the speech output, to indicate at least one available FM channel from the rated list of available FM channels. In an embodiment, the tuning signal may include RDS data to be displayed on a display of the FM radio 110. If such capability is present in the FM radio 110, the RDS data may be processed by the FM radio 110 to bring about selection of and tuning to the at least one FM channel.

During use of the hands-free device 102 in an automobile for example, a user may enter the range of a broadcast transmission on the same FM channel as currently used by the hands-free device. In that event the hands-free device 102 may determine that the transmission frequency of FM transmitter 122 should be changed to another of the available FM channels, and that the currently used FM channel should no longer be utilized. The controller 124 may activate the speech synthesizer 138 to indicate a new available FM channel from the rated list 132 of available FM channels. The instruction module 130 may be configured to generate an updated rated list 132 of available FM channels. The device 102 may include a speaker 138, as mentioned above, to provide audio output under circumstances when use of the FM transmitter 122 may not practical, for example, near strong sources of interference, such as power lines or powerful broadcast antennas.

The hands-free device 102 may include a microphone 140 as mentioned above, and in this way may enable use of the hands-free device 102 in place of the handheld mobile communication device 106. The microphone 140 may be coupled to the short range transceiver 116 and configured to capture speech input so that the short range transceiver 116 can transmit speech input of the microphone 140 to the handheld device 106 via circuitry configured to receive speech input to generate an output signal transmitted via the short range transceiver 116. In this way, the hands-free device 102 may be used by the user in voice communication, for example, for a cellular telephone call.

The hands-free device 102 may include capabilities to enhance use of the microphone 140. For example, echo cancellation techniques may be employed to support use of a mobile communication device 106 with the hands-free device 102 in a speakerphone mode. Moreover, noise suppression may be employed to reduce or eliminate the effects of road noise. The hands-free device may include capability to mute the speaker 138 and microphone 140 and/or to suppress transmission of received short range communication by the FM transmitter 122, to mute music output of the handheld device or to support a privacy capability. When the mute capability is activated for privacy, a user may still continue the conversation through direct use of the handheld device.

Some mobile communication devices, or other handheld devices 106, may support voice recognition. In an embodiment the hands-free device 102 may transparently pass on to the handheld device 106 any speech input received by the microphone 140. In this way the hands-free device 102 may support features of a mobile communication device 106 such as voice dialing.

The hands-free device 102 may include other capabilities to enhance use of the handheld device 106. For example, the hands-free device 102 may include a text-to-speech capability. In the event that the handheld device may receive SMS or other text messages, a capability may be included to speak a message via the hands-free device 102. Phone navigation may be supported as well, in which a user may receive driving instructions via the handheld device 106, the instructions then being announced via the speaker 138 of the hands-free device or via the speakers of the car FM radio 110. It is understood that any sound that may be audible over a mobile communication device 106 may be transferred to the FM radio 110 by the hands-free device 102.

The hands-free device 102 may include a capability to control music functions of the handheld device. For example, a mobile communication device 106 may include music streaming functionality, and/or may include for example, an MP3 player capability. The handheld device 106 may provide music playing functionality, but not mobile communication functionality. The hands-free device 102 may include buttons or other controls for the handheld device's music functions, and/or may use speech recognition for control.

For example, the hands-free device 102 may include a button for play/pause, a button for forward track/back track, and the like, along with a control for volume. Other buttons on the hands-free device 102 may provide for redial and other communication capabilities of the mobile communication device 106. It is understood that in a multi-function hands-free device 102 use of the music functionality of the mobile communication device 106 may be preempted by an incoming telephone call. That is, the hands-free device 102 may be configured along with the mobile communication device 106 so that incoming, or outgoing, voice communications take priority over music functions of the handheld device 106.

FIG. 2 is a flowchart of an embodiment of a method 200 for generating a rated list and an updated rated list by a hands-free electronic device 102 (see FIG. 1). As discussed above, the hands-free device 102 includes an FM scanner 126 configured to scan for FM channels and to locate available FM channels. The FM scanner 126 may be coupled to an FM receiver 120 that may be included in the hands-free device 102. As previously discussed, the hands-free device 102 may include in addition a short range transceiver 116, an FM transmitter 122, and a memory 134.

In a step 220, the method 200 includes receiving an FM signal via the FM receiver 120. The received FM signal may include an FM signal transmitted by the FM transmitter 122 that may provide a reference standard for signal strength, and may include an FM signal 118 transmitted by the remote FM transmitter 114. In a step 226, the method 200 includes continuously scanning for FM channels, by the FM scanner 126 (see FIG. 1), to locate available FM channels. The scanning 226 may be in accordance with FM signals that may be received by the FM receiver 120.

The method 200 may include determining a signal-to-noise ratio (SNR) value 242 for the FM signal received by the FM receiver 120 (see FIG. 1) in step 220, by the SNR module 142. The SNR may be determined since the FM transmitter 122 may provide a reference standard for signal strength, for the FM signal 118 received by the FM receiver 120.

Similarly, the method 200 may include determining a received signal strength indication (RSSI) 244, via the RSSI module 144 (see FIG. 1). Either or both of SNR and RSSI may be used by the hands-free device 102 to assess FM channel quality. It is understood that other criteria may be used. According, the FM channels may be rated, by the rating module 148, and a rated list 132 of the available FM channels accordingly may be generated by the hands-free device 102, by the list module 150. In an embodiment the method may include storing the rated list 132 in memory 134 for later access.

The hands-free device 102 (see FIG. 1) may determine whether the current FM channel in use by the device 102 is freer of interference than other FM channels in the rated list 132. A query may be made 246 if the current FM channel is freer of interference than other FM channels in the list 132. If the answer is “NO,” the method 200 may discard 250 the current channel from the rated list 132. If the answer to the query 246 is “YES,” the available FM channels may continue to be rated 248 and the method may return to the step 220 of receiving an FM signal. The method may include updating the rated list 132 as RSSI and SNR values change for FM channels that may be available, and/or as additional FM channels become available. That is, the method may include generating an updated list of rated available FM channels.

During use of the hands-free device 102 (see FIG. 1) in combination with the handheld device 106, short range communications 104 may pass between the hands-free device 102 and the handheld device 106. Accordingly, the method 200 may include transmitting and/or receiving short range communications 104 via the short range transceiver 116 from the handheld device 106. A short range communication 104 received via the short range transceiver 116 from the handheld device 106 may be transmitted to the FM radio 110 via the FM transmitter 122 on at least one of the available FM channels on the rated list 132. Accordingly, the method may include transmitting received short range communications 104 via at least one of the available FM channels of the rated list 132 of available FM channels.

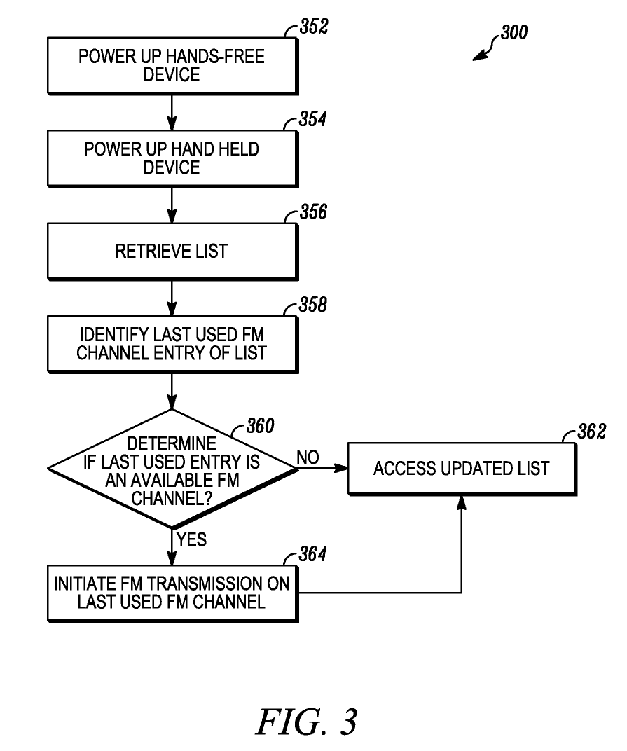

FIG. 3 is a flowchart of an embodiment of a method 300 for powering up and initiating the FM communication 108 (see FIG. 1) between the hands-free electronic device 102 and the FM radio 110 according to the last used FM channel. The method 300 may commence 352 with powering up the hands-free device 102. In a step 354, a handheld device 106 may be powered up. It is understood that step 352 and step 354 may take place in a different order. Following power-up, the two devices may initiate communication with one another by, for example a Bluetooth protocol, a WiFi protocol, or by another protocol.

As discussed above, the hands-free device 102 (see FIG. 1) may maintain in a memory 134 a rated list 132 of available FM stations. The hands-free device may retrieve 356 the rated list 132. In an embodiment, the last used FM channel may be ranked first on the rated list 132 of available FM channels, as previously discussed. The method 300 may identify 358 the last used FM channel entry on the list by choosing the first ranked entry of the list, or in another manner.

In the method 300, a query may be made 360 to determine if the last used entry of the rated list 132 (see FIG. 1) is an available FM channel. If the answer to the query 360 is “NO,” the rated list 132 may be accessed for update to remove the last used entry from the list 362, and to provide for continuous update of the rated list according to rating module 148 and list module 150. If the response to the query 360 is “YES,” FM transmission 108 to the FM radio may be initiated 364 on the last used FM channel. The method 300 may access the rated list 132 for update 362, again, to provide for continuous update of the rated list according to rating module 148 and list module 150.

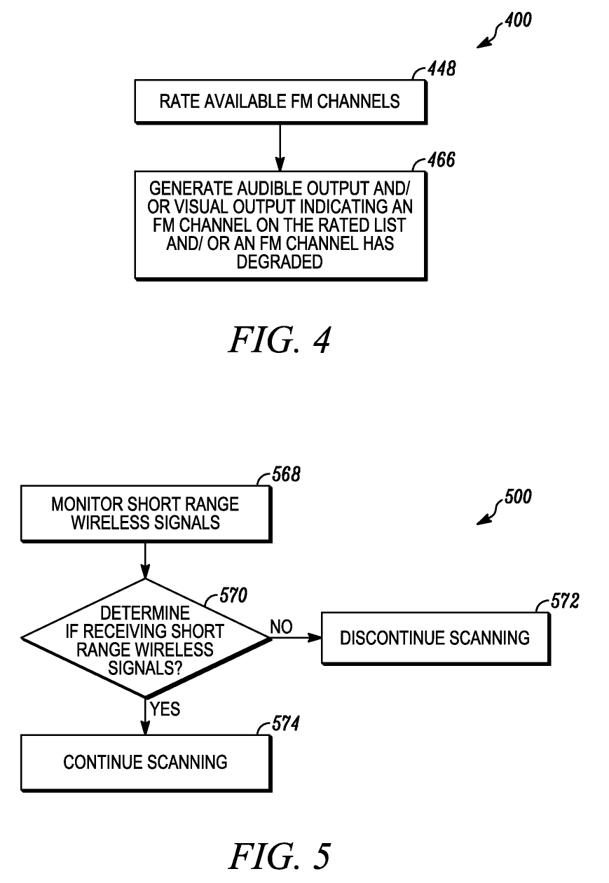

FIG. 4 is a flowchart of an embodiment of a method 400 for informing the user as to which channel to tune the FM radio 110 (see FIG. 1). That is, in the method 400 a user may receive information from the hands-free device 102 to tune the FM radio 110 to a particular FM channel that is substantially free of interference as has been determined by the hands-free device 102. In this way, the hands-free device may provide to the user the information that may direct the user to tune the FM tuner 110 to a particular FM channel that the hands-free device 102 has automatically determined to be substantially free of interference.

In a step 448 the hands-free device 102 (see FIG. 1) may generate a rated list 132 of available FM channels. Generation of the rated list 132 has been discussed above. The rated list 132 be stored in memory 134, or may have been previously generated and retrieved from memory 134.

The hands-free device 102 (see FIG. 1) may include a speech synthesizer 136, as previously discussed. The speech synthesizer 136 may be configured to produce speech output to indicate an available FM channel from the rated list 132 of available FM channels. In this way a user may receive an audible indication of an FM channel to which to manually tune the FM radio 110. Accordingly, the method 400 may include 466 generating audible output such as a tone, and/or speech output produced by a speech synthesizer 136 to indicate at least one available FM channel from the rated list 132 of available FM channels. Besides generating speech output that may be provided by the hands-free device 102 to a speaker 138, the FM transmitter 122 may transmit a signal including the speech output, to indicate at least one available FM channel from the rated list of available FM channels.

The FM transmitter 122 (see FIG. 1) may transmit a signal including RDS data to be displayed on a display of the FM radio 110. Accordingly, the method 400 may include 466 generating speech output and/or visual output indicating an FM channel has degraded, and/or to indicate a more highly rated channel available on the rated list 132 of available FM channels.

Some FM radios include a capability to display RDS data, as previously mentioned. Besides generating speech output that may be provided to a speaker 138 (see FIG. 1), the FM transmitter 122 may transmit a tuning signal including the speech output, to indicate at least one available FM channel from the rated list of available FM channels. In an embodiment, the tuning signal may include RDS data to be displayed on a display of the FM radio 110. Accordingly, the method 400 may include generating at least one of a visual automatic indication and an audible automatic indication, if the at least one of the available FM channels of the rated list 132 of FM channels has degraded and a more highly rated channel is available on the rated list 132 of available FM channels.

FIG. 5 is a flowchart of an embodiment of a power saving method 500 of the hands-free electronic device 102 (see FIG. 1). When short range communications 104 are no longer received from a handheld device such as device 106, there may no longer be a need to continuously scan for available FM channels. Accordingly, the method 500 may include discontinuing scanning when the short range transceiver 116 receives no short range communications 104.

The method 500 includes monitoring short range wireless signals 568 for short range wireless communications 104 (see FIG. 1) from the handheld device 106. A query may be made 570 if the hands-free device 102 is receiving short range wireless signals. It the answer to the query 570 is “NO,” then the FM scanner 126 of the hands-free device 102 may discontinue scanning for available FM channels 572 thereby limiting power usage when the handheld device 106 is not in use. If the answer to the query 570 is “YES,” the FM scanner 126 of the hands-free device 102 may continue scanning for available FM channels 574. In this manner the rated list 132 of available FM channels may be maintained up-to-date so long as the handheld device 106 is in use with the hands-free device 102.

It may be beneficial to automatically process an available FM channel by a hands-free device 102 (see FIG. 1), in order to reduce distraction safety issues of operating communication devices during the operation of a motor vehicle. In the disclosed hands-free device 102, in the event that the FM tuner 110 were configured to receive tuning information from the hands-free device 102, and were configured to automatically tune to an available FM channel, the process may be completely hands-free. Otherwise, in the disclosed hands-free device 102 a user may receive audible information from the hands-free device to tune the FM tuner 110 to a particular FM channel that has been determined by the hands-free device 102 to be substantially free of interference. In this way, the hands-free device 102 can provide to the user the information that may direct the user to tune the FM tuner 110 to a particular FM channel that the hands-free device has automatically determined to be substantially free of interference. In this way safety issues associated with a user having to process available FM channels may be mitigated.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device, comprising:
a controller;
an FM receiver coupled to the controller;
an FM scanner coupled to the receiver and configured to continuously scan for FM channels and to locate available FM channels;
an instruction module coupled to the controller and configured to generate a rated list of the available FM channels;
a memory coupled to the controller and configured to store the rated list of the available FM channels;
a short range transceiver coupled to the controller and configured to transmit and receive short range communications; and
an FM transmitter coupled to the controller and configured to transmit received short range communications via at least one of the available FM channels of the rated list of available FM channels.

2. The device of claim 1, further comprising:
a speech synthesizer coupled to the controller configured to generate speech output to indicate at least one available FM channel from the rated list of available FM channels.

3. The device of claim 1, wherein the FM scanner is configured to discontinue scanning when the short range transceiver receives no short range communications.

4. The device of claim 1, wherein the rated list includes as a first entry a last used available FM channel.

5. The device of claim 1, wherein:
the receiver is configured to determine a signal-to-noise ratio value, and a received signal strength; and
the rated list of available FM channels is rated according to a signal-to-noise ratio (SNR) value and a received signal strength indication (RSSI).

6. The device of claim 1, wherein:
the FM scanner is configured to continuously scan for FM channels to locate available FM channels; and
the instruction module is configured to generate an updated rated list of available FM channels.

7. The device of claim 1, wherein the short range transceiver is at least one of a Bluetooth transceiver or a WiFi transceiver.

8. The device of claim 1, wherein the controller is configured to initiate a transmission of a tuning signal to indicate at least one available FM channel from the rated list of available FM channels.

9. The device of claim 1, further comprising:
a microphone configured to capture speech input wherein the short range transceiver is configured to transmit speech input of the microphone.

10. The device of claim 1, further comprising:
circuitry configured to receive speech input to generate an output signal transmitted via the short range transceiver.

11. An electronic device, comprising:
a controller;
an FM receiver coupled to the controller;
an FM scanner coupled to the controller and configured to continuously scan for FM channels and to locate available FM channels;
an instruction module coupled to the controller and configured to generate a rated list of the available FM channels;
a short range transceiver coupled to the controller and configured to transmit and receive short range communications;
an FM transmitter coupled to the controller and configured to transmit received short range communications via at least one of the available FM channels of the rated list of available FM channels; and
a speech synthesizer coupled to the controller and configured to generate speech output to indicate at least one available FM channel of the available FM channels.

12. The device of claim 11, wherein the FM scanner is configured to discontinue scanning when the short range transceiver receives no short range communications.

13. The device of claim 11, further comprising:
a memory coupled to the controller and configured to store the rated list of the available FM channels.

14. The device of claim 11, wherein:
the FM scanner is configured to continuously scan for FM channels to locate available FM channels; and
the instruction module is configured to generate an updated rated list of available FM channels.

15. A method of an electronic device comprising an FM receiver, an FM transmitter, a short range transceiver, an FM scanner configured to scan for FM channels and to locate available FM channels, and a memory, the method comprising;
receiving FM signals via the FM receiver;
scanning continuously for FM channels to locate available FM channels in accordance with the FM signals;
generating a rated list of the available FM channels;
storing in the memory the rated list of the available FM channels;
receiving short range communications via the short range transceiver; and
transmitting received short range communications via at least one of the available FM channels of the rated list of FM channels via the FM transmitter.

16. The method of claim 15, further comprising:
generating speech output by a speech synthesizer to indicate at least one available FM channel from the rated list of available FM channels.

17. The method of claim 15, further comprising:
generating an updated list of rated available FM channels.

18. The method of claim 15, further comprising:
discontinuing scanning when the short range transceiver receives no short range communications.

19. The method of claim 15, further comprising:
generating at least one of a visual automatic indication and an audible automatic indication, if the at least one of the available FM channels of the rated list of FM channels has degraded and a more highly rated channel is available on the rated list of available FM channels.

20. The method of claim 15, further comprising:
determining, for an available FM channel, a signal-to-noise ratio value and a received signal strength; and
rating the available FM channels according to a signal-to-noise ratio (SNR) value and a received signal strength indication (RSSI).
